(19) United States
(12) Patent Application Publication
(10) Pub. No.: US 2004/0215526 A1
(43) Pub. Date: Oct. 28, 2004

(54) Interactive shopping and selling via a wireless network

(76) Inventors: Wenjun Luo, Cupertino, CA (US); Michael Liu, Fremont, CA (US); Lisa K. Y. Wong, South San Francisco, CA (US)

Correspondence Address: PERKINS COIE LLP, PATENT-SEA, P.O. BOX 1247, SEATTLE, WA, 98111-1247, US

(21) Appl. No.: 10/663,854

(22) Filed: Sep. 16, 2003

Related U.S. Application Data
(60) Provisional application No. 60/483,460, filed on Jun. 30, 2003.
(60) Provisional application No. 60/461,031, filed on Apr. 8, 2003.

(51) Int. Cl. G06F 17/60

(52) U.S. Cl. 705/26

(57) ABSTRACT

A method, system, and computer-readable medium is described for providing users of wireless mobile phones and other wireless devices with the ability to participate in e-commerce transactions, such as by using a message-based mechanism that exchanges information over a wireless telephone network (e.g., SMS messages). The e-commerce transactions can have a variety of types, including traditional and Dutch auctions. Sellers of items may also be provided various functionality, such as the ability to define and execute sales campaigns for their items and to monitor the progress of such sales campaigns. This abstract is provided to comply with rules requiring an abstract, and it is submitted with the intention that it will not be used to interpret or limit the scope or meaning of the claims.

### CROSS REFERENCE TO RELATED APPLICATIONS

This application claims the benefit of provisional U.S. patent application 60/483,460, filed Jun. 30, 2003 and entitled “Process, System And Method For Interactive Shopping And Selling Via A Wireless Network,” which is hereby incorporated by reference in its entirety.

This application is also related to provisional U.S. patent application No. 60/461,031, filed Apr. 8, 2003 and entitled “Process, System And Method For Trading Goods, Information and Services Via A Wireless Network”, which is also hereby incorporated by reference in its entirety.

### TECHNICAL FIELD

The following disclosure relates generally to interactive shopping and selling over a wireless network, such as based on exchanging SMS messages with cellular telephones to enable users of the phones to place bids on Dutch auctions.

### BACKGROUND

The use of wireless cellular telephones (or “cell phones”) is becoming increasingly popular worldwide, and in many countries the population of owners of cellular and other wireless phones far exceeds the population of personal computer owners. However, to interact with the growing number of typical e-commerce systems (e.g., to engage in e-commerce transactions for items, such as to buy or sell products and/or services), users need to use wired devices having Internet access (e.g., personal computers). Unfortunately, such restrictions prevent many people from effectively participating in such e-commerce transactions. For example, many people do not have access to such wired devices with Internet access (although they may be owners of wireless phones), and even some people that do have such Internet access may be reluctant to shop on the Internet (e.g., due to security concerns, concerns for fraud, privacy issues, etc.) and/or may face constraints that limit the availability of such Internet access (e.g., based on location and/or time). Moreover, Internet-based e-commerce transactions are typically difficult or impossible to complete for people who are unable to obtain a credit card, such as minors as well as many people in countries where the use of credit cards is not common.

Thus, providing owners of wireless telephones with the ability to effectively engage in e-commerce transactions would have significant utility, as many such owners could then conduct shopping in a safe, private, and protected environment without time and place limitations.

### BRIEF DESCRIPTION OF THE DRAWINGS

FIG. 1 is a network diagram illustrating various devices interacting in one embodiment of a wireless marketplace shopping network.

FIG. 2 is a block diagram illustrating an embodiment of a computing system suitable for managing a wireless marketplace.

FIGS. 3A and 3B are block diagrams illustrating additional details of computing systems and interactions that in some embodiments facilitate interactions of wireless telephones with a wireless marketplace.

FIG. 4 is a flow diagram of an embodiment of the Wireless Marketplace Manager routine.

FIG. 5 is a flow diagram of an embodiment of a User-Initiated SMS-Based Registration routine.

FIG. 6A is a flow diagram of an embodiment of a User-initiated SMS-Based Login routine, and FIG. 6B provides examples of SMS messages that could be exchanged as part of the routine.

FIG. 7A is a flow diagram of an embodiment of a System-Initiated SMS-Based Opt-In routine, and FIG. 7B provides examples of SMS messages that could be exchanged as part of the routine.

FIG. 8 is a flow diagram of an embodiment of a User-initiated SMS-Based Opt-In routine.

FIG. 9 is a flow diagram of an embodiment of a Campaign Planning routine.

FIG. 10 is a flow diagram of an embodiment of a Campaign Execution routine, and FIG. 11 provides examples of SMS messages that could be exchanged as part of the routine.

FIG. 12 provides examples of SMS messages that could be exchanged as part of a category-based opt-in routine.

FIG. 13 provides examples of SMS messages that could be exchanged as part of a routine for changing user account information.

FIG. 14 is a network diagram illustrating interactions between various devices and modules in one embodiment of a wireless marketplace.

FIG. 15 is a network diagram illustrating additional details about interactions in a Transaction Manager module in one embodiment.

FIG. 16 is a network diagram illustrating additional details about interactions in a SMS Interface module in one embodiment.

FIG. 17 is a flow diagram illustrating additional details about processing performed by a Transaction State Manager in one embodiment.

FIG. 18 is a flow diagram illustrating additional details about interactions in a Match Finder module in one embodiment.

### DETAILED DESCRIPTION

A software facility is described below that provides users of wireless mobile phones and other wireless devices with the ability to participate in e-commerce transactions, such as by interactively shopping via a wireless marketplace (also referred to as a wireless shopping network, or “WSN”). For example, in some embodiments items are available as part of one or more auctions (e.g., Dutch auctions), and the facility assists users of the wireless devices in placing bids on the auctions. In addition, in some embodiments the e-commerce transactions occur using a message-based mechanism that exchanges information over a wireless telephone network (e.g., via Short Message Service (or “SMS”) messages over the Global System for Mobile Communications (or “GSM”) network). Moreover, in some embodiments the facility provides billing functionality via interactions with a billing system of the wireless telephone network in use, such as via Premium SMS.

The software facility also interacts with merchants and other sellers of items in some embodiments in order to provide various functionality, such as graphical user interfaces to allow the sellers to define and execute sales campaigns for their items and to monitor the progress of such sales campaigns. The facility can assist in accomplishing the sales campaigns in a variety of ways, such as by matching potentially interested buyers with a sales campaign (e.g., based on a previously expressed interest of those buyers in items of the current type), by providing information for the sales campaign directly to the wireless telephones of users, by facilitating in providing sales campaign information to potential buyers via other information distribution channels (e.g., the Internet, fax, radio, TV, IVR systems), etc. For example, in some embodiments some wireless telephone users may learn about ongoing and/or upcoming auctions (or, in other embodiments, about items available via other selling mechanisms) from information provided via a broadcast mechanism, such as television (e.g., via paid commercials or other advertisements during any program, or instead as part of a channel or program that focuses on shopping or more particularly on such auctions and/or items available via other selling mechanisms)—such users may then be able to participate in the auctions or other selling mechanisms by initiating an appropriate message with their wireless telephones (e.g., to the seller in a manner identified in the provided information). In some such embodiments, the users may also obtain additional related information via the same or a related broadcast mechanism, such as to allow a user to monitor the progress of an auction or other selling mechanism (e.g., by displaying information about a current number of bidders and the current bid price).

In some embodiments, a WSN that is supported by the software facility is made accessible to a variety of types of users via both wireless and wired devices. The facility may have access to a number of databases, such as databases storing account and activity information of users of the WSN, identification of available items and their related selling information/mechanisms, and offers or other purchasing information for buyers. The facility may also in some embodiments include or have access to functionality to control one or more user interfaces (e.g., having multiple user interfaces to correspond to different front-ends, such as to ensure that the WSN is easy to use via devices of different types, including wireless devices with limited-sized displays), to identify successful matches between buyers and sellers, such as based on criteria set forth by the sellers and/or the buyers (e.g., to select winners of auctions), to provide easy billing service (e.g., via a billing system in use by a wireless operator).

The WSN may also in some embodiments offer advanced personalized services to users, such as based on their location (e.g., when location-based information for users is available via wireless operators). For example, the WSN system may interface with a carrier location database in order to either pull/retrieve user location information or to instead receive notification of user location changes from the carrier system (i.e., by having that information pushed to the WSN). Such user location information can then be used in various embodiments to assist in one or more of various operations, including selecting target users for a specific campaign (e.g., all those who are near a movie theater for a movie ticket sales campaign), selecting winners (e.g., only those who are inside a retail store will be considered as winners), and/or assisting winners in obtaining their product or other award (e.g., by notifying a user of a direction from his current location to a pick up site for a product that was won).

Similarly, in some embodiments the facility and WSN may provide Interactive Voice Response (“IVR”) capabilities to allows users of wireless and wired telephones to receive information (e.g., information related to auctions and other selling mechanisms) and/or to provide information (e.g., to interact with a selling mechanism in order to perform shopping, or to provide administrative information, such as for registration). For example, users can be provided an appropriate telephone number (e.g., a toll-free number) to access an IVR interface that allows the users to place bids for auctions and to monitor the status of auctions.

In addition, a user must in some embodiments first register as a member of the WSN before they can conduct any shopping and selling activities via the WSN, and may also have to prove membership upon every use of the WSN, while in other embodiments such registration may be optional (or not available) for buyers and/or sellers. Various embodiments can also support virtually any shopping/selling mechanism, including fixed price offers, traditional auction format, Dutch auctions, reverse bidding, price guessing, price naming, one-price bidding, last minute sales, mass buying/selling, etc. In addition, supported e-commerce transactions include not only purchase and sale transactions, but virtually any other form of transaction as well (e.g., bartering, lending, leasing, licensing, borrowing, etc.), and may also occur between various types of entities (e.g., merchant-to-merchant, between customer and merchant, between private individuals, between an organization and its suppliers and/or distributors, involving three or more distinct entities, etc.).

In some embodiments, supporting fixed price offers includes using typical ads with product information and an indication of the fixed price which are provided to potential buyers (e.g., as SMS messages), with the potential buyers able to reserve and/or purchase the product at that fixed price (e.g., via an SMS message). In some embodiments, supporting traditional auctions includes allowing users to sell only one unit or copy of a product at a time, with the winner of the auction being the buyer that offers the highest price. In some embodiments, supporting Dutch auctions includes supporting one or more of various additional auction-related features (some of which may not be available with traditional auctions), including the following: offering multiple copies or units of a product as part of a single auction, but in such a manner that different copies can be awarded to different bidders; supporting a minimum bid price or other minimum criteria for a successful bid; supporting re-bidding (i.e., offering a higher price that overrides a previous bid), supporting uniform pricing in which each winner pays the minimum winning bid price (even if he/she had offered more); supporting differential pricing in which each winner pays the price he/she offered (rather than the minimum winning bid price); etc. In some embodiments, supporting reverse bidding (also referred to as “reverse auctions”) includes allowing users to act as service or product providers (e.g., as contractors), and to win a contract by offering the lowest price or other most favorable terms for specified criteria (e.g., fastest completion date). In some embodiments, supporting price guessing includes allowing users to send in guesses of a product price (e.g., via SMS messages), such as after the users are notified of the features of the product—winners may then be determined in various ways, such as based on the submission time, how close the guess is to the actual price, how many winners are to be picked (e.g., if it's decided that 5 winners are to be picked, the winners are those whose guess are the closest to the actual price, and the earliest), etc. In some embodiments, supporting price naming includes allowing a seller to engage in a one-time consideration of a price offered by a user (regardless of what others offer). In some embodiments, supporting last minute sales includes offering a product that has a time stamp mandating that a bid be submitted before a specified deadline in order to be considered (e.g., based on a fixed price for the product). In some embodiments, supporting mass buying/selling includes allowing a price of a product to vary depending on how many users offer to buy the product (e.g., a product will be sold for $500 if there are 100 buyers, but for $400 if there are 200 buyers), while in other embodiments the product price is determined by the timing of bid as well (e.g., when the 199^{th} bidder sends in his bid, his product price will still be $500, but the next bidder (#200) will get a product price of $400 because by that time the total number of bidder exceed the example threshold of 200 buyers.

For illustrative purposes, some embodiments of the software facility are described below in which the e-commerce transactions are Dutch auctions and in which information is exchanged with wireless cell phones via SMS messages over a GSM wireless telephone network. However, those skilled in the art will appreciate that the techniques of the invention can be used in a wide variety of other situations, and that the invention is not limited to these illustrative details. For example, in some embodiments information may be exchanged using MMS (“Multimedia Message Service”) messages or via mechanisms that are not message-based. In addition, wireless protocols or systems that can be used to exchange information include Personal Communications Services (“PCS”), Enhanced Data GSM Environment (“EDGE”), the i-mode service, Time Division Multiple Access (“TDMA”), Code-Division Multiple Access (“CDMA”), wideband CDMA (or “WCDMA”), and 802.11 protocol, Bluetooth, WAP (“Wireless Application Protocol”), cHTML, HTML, J2ME, location-based services, etc.

The following example shows a typical sequence of actions by a user when participating in a simple Dutch Auction transaction. In particular, Jenny sees an ad indicating that there is a daily wireless Dutch auction on a variety of goods of interests, and decides to give it a try. Jenny then obtains an explanation of how the system works (e.g., by walking into an auction location and reading a poster with simple instructions, or instead accessing such information in an online manner), which indicates that each bid should be an SMS message sent to a designated number that includes a reference id for the auction, a bid price, and optionally a number of goods requested at the bid price. The Dutch auction imposes restrictions that the bid price needs to be higher than a specified minimum price, ranks bids from highest to lowest, selects as the winners the top bidders (e.g., with the number of winners being equal to or less than the number of goods on auction, depending on whether any of the winners purchase more than one of the goods), determines the final purchase price to be equal to the lowest bid price of the winners, and notifies the winners by the end of the campaign date. The winners will then need to come back to the auction location to pay and pick up the goods in this example.

Jenny then reviews the goods on auction today and decides to make a bid —after she types in the bid with her offering price and sends it to the designated number, she receives a confirmation message telling her that the results will be sent out by an indicated target date. Some time later, she receives an SMS message telling her that she won the auction and that the price is lower that what she offered. The SMS message can also indicate that she has been charged a deposit fee and that she has to pick up the goods by a specified date, so Jenny goes to the auction site to pay for and pick up her goods.

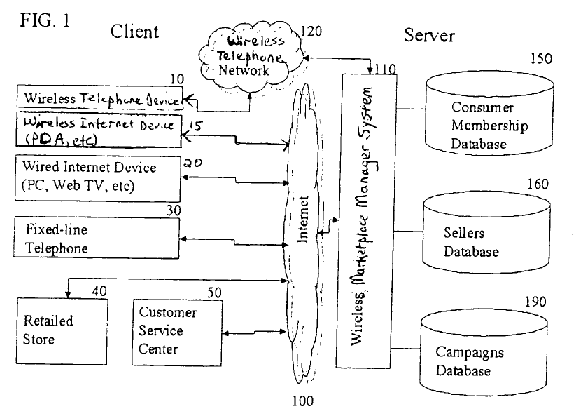

FIG. 1 is a network diagram illustrating various devices interacting in one embodiment of a wireless marketplace shopping network. In particular, an exemplary Wireless Marketplace Manager (“WMM”) system facility 110 is accessible from a wireless telephone device 10 through a wireless telephone network 120, as well as via the Internet 100 from various devices that include a wireless Internet device 15 (e.g., a communication-enabled PDA), a wired device 20 with Internet access (e.g., a personal computer, web-enabled television, etc), and a fixed-line telephone 30. The WMM system can interact with various accessible databases in the illustrated embodiment, including a consumer membership database 150, a seller database 160, and a campaign database, as well as other external systems via the Internet, including computing systems at retail stores 40 and at customer service centers 50.

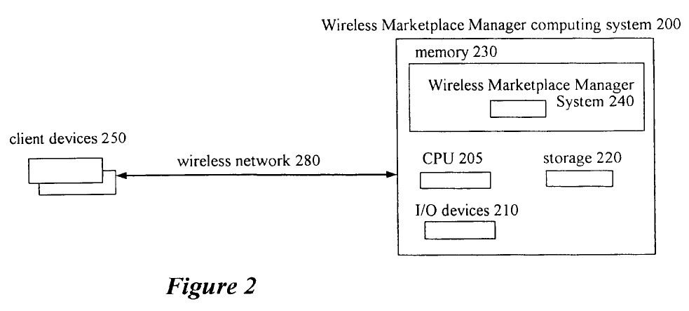

FIG. 2 is a block diagram illustrating an embodiment of a computing system suitable for managing a wireless marketplace, and in particular illustrates the WMM computing system 200 in communication with multiple client devices 250 via a wireless network 280. The WMM computing system includes a CPU 205, various I/O devices 210, storage 220, and memory 230. While not illustrated here, example I/O devices include a display, one or more input device, a network connection, a computer-readable media drive, and optionally other I/O devices. An embodiment of a WMM system 240 is executing in memory, and in some embodiments it may include a variety of specialized components and/or modules (not shown). In addition, the WMM system may also interact with a variety of other computing systems and/or information sources to provide various functionality, which are not illustrated in this example embodiment.

While not illustrated in detail in this example embodiment, the client devices can also include various components that assist in interactions with the WMM system, including memory, a processor, a receiver/transmitter, an input device 14 (e.g., a keyboard, a voice recognition device, etc.) and an output device 15 (e.g., a LCD screen, a display, a monitor, a sound device, etc.). Various information may be stored in active memory and/or longer-term storage, including software applications, a subscriber profile, and a unique identification number. The client devices can also remotely communicate with or otherwise access the WMM system in a variety of ways, such as via software proprietary to the WMM system or instead based on a standard communication mechanism (e.g., a Web browser, an SMS message component, etc.).

More generally, those skilled in the art will appreciate that computing devices 200 and 250 are merely illustrative and are not intended to limit the scope of the present invention. A “client” or “server” may comprise any combination of hardware or software that can interact in the manner described, including computers, network devices, internet appliances, PDAs, wireless phones, pagers, electronic organizers, television-based systems and various other consumer products with inter-communication capabilities. In addition, computing device 200 may be connected to other devices that are not illustrated, including through one or more networks such as the Internet or via the World Wide Web (WWW). In addition, in some embodiments various of the described functionality may not be provided and/or other additional functionality may be available.

Those skilled in the art will also appreciate that, while various items may be described as being stored in memory or on storage, these items or portions of them can be transferred between memory and other storage devices for purposes of memory management and data integrity. Alternatively, in other embodiments some or all of the software modules and/or components may execute in memory on another device and communicate with the illustrated computing device via inter-computer communication. Some or all of the system components or data structures may also be stored (e.g., as instructions or structured data) on a computer-readable medium, such as a hard disk, a memory, a network, or a portable article to be read by an appropriate drive. The system components and data structures can also be transmitted as generated data signals (e.g., as part of a carrier wave) on a variety of computer-readable transmission mediums, including wireless-based and wired/cable-based mediums. Accordingly, the present invention may be practiced with other computer system configurations.

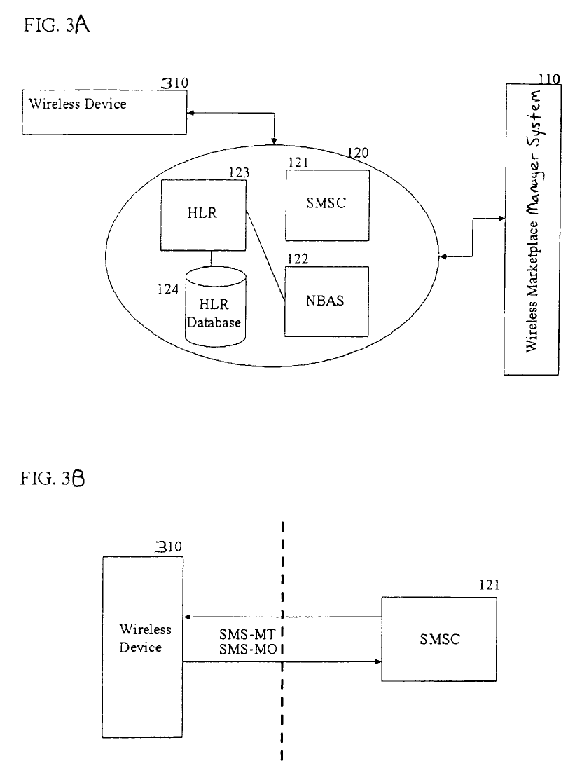

FIGS. 3A and 3B are block diagrams illustrating additional details of computing systems and interactions that in some embodiments facilitate interactions of wireless telephones with a wireless marketplace. In particular, a wireless device 310 is communicating with the wireless telephone network 120 using SMS messages in this example embodiment. The wireless telephone network 120 can include various interacting computing systems in various embodiments, and in the illustrated embodiment includes an SMS Center (SMSC) 121 that supports an appropriate two-way protocol (e.g., over the TCP/IP transport connection) with the wireless device, as well as a Home Location Register (“HLR”) system 123, HLR database 124 and NBAS 122, and with an SMS-Mobil Terminated (SMS-MT) message used for sending wireless messages to the wireless device 310. After the wireless device receives the SMS messages, it displays the content of the message through an output device to its user. When the user replies to a message (e.g., by issuing a “Reply” command to device 310 via an input device), the user may specify the content of the reply message, and then send the reply message (e.g., by issuing a “Send” command). In this illustrated embodiment, device 310 automatically sets the destination number of the message to be the same as the sender number from the original SMS-MT message, although in some embodiments the user may be asked to verify that destination number before the message is sent. The reply message will be sent in this embodiment as an SMS-Mobile Originated (SMS-MO) message.

In addition to SMS, the wireless device 310 can in some embodiments also store software that facilitates an environment similar to those used in instant messaging and chat room applications. In such applications, the user sends and receives text messages over the air through wireless device in a manner similar to SMS, but unlike in SMS, the user does not need to manually retrieve each new message from the “Inbox” and does not need to be manually issue a “Reply” command with every reply message. Instead, a user need only key in the content of each reply message, followed by a press of the “Send” button. All messages the user send out to and receive from the same number during a chat session are stored in the wireless device and displayed as a continuous stream of text.

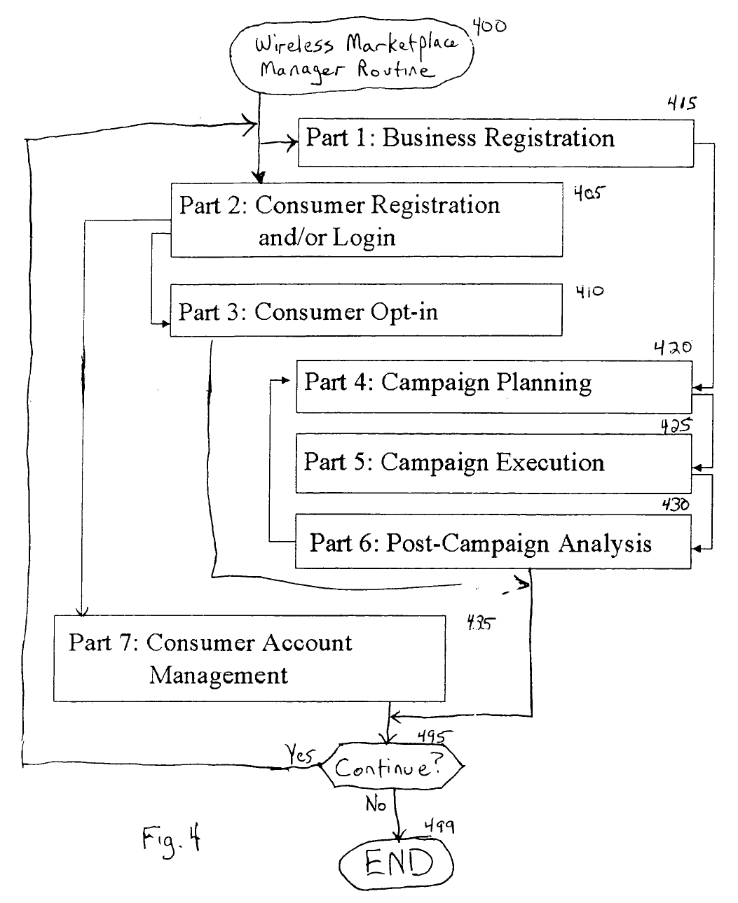

FIG. 4 is a high-level flow diagram 400 of actions performed by a Wireless Marketplace Manager system in an exemplary embodiment. In particular, in this illustrated embodiment there are seven primary types of functionality performed by the WMM system. In particular, sellers register with the system (e.g., via a Web-based user interface) in Part 1, Business Registration 415. Sellers can be individuals or corporations, and in this illustrated embodiment registration is mandatory for sellers. In Part 2, Consumer Registration 405, consumers register with the WMM system, which in this illustrated embodiment is not mandatory for consumers to use the system (although some campaign flows may be specified by a seller to target or include only registered consumers). In Part 3, Consumer Opt-In 410, consumers (regardless of whether or not they are registered with the WMM system), can specify categories (e.g., lifestyle, product, etc.) of their interests by choosing from a selected list of categories, with the specifying indicating an “opt-in” to receive information related to the specified categories. The system will then use the opt-in selections as a basis to provide consumers with item campaign information that is likely to be of interest to them.

In Part 4, Campaign Planning 420, sellers use the WMM system to plan new campaigns, such as by determining the campaign schedule and the campaign style and flow, including the actual contents of the messages to be delivered to the consumers throughout each phase of the campaign. Sellers may also use previous campaign data in the system in determining the target consumer community. In Part 5, Campaign Execution 425, sellers launch the planned campaigns and use the WMM system to monitor and manage the campaign progress throughout each phase (e.g., from advertising to the collection of consumer responses; to campaign results announcement, and finally product distribution). In Part 6, Post-Campaign Analysis 430, sellers use the WMM system to analyze the effectiveness of the campaign based on the data collected by the system throughout the campaign. In Part 7, Consumer Account Management 435, consumers who have registered with the system can access and change their account information such as their opt-in selections at any time.

Additional example details regarding the actions of the WMM in this exemplary embodiment include the following. With respect to Business Registration in Part 1, all sellers are required to register to use the system. Sellers can be individuals as well as businesses of any size, and are asked to provide their contact information (e.g., name, address, and contact phone numbers) and the method by which they preferred to be billed for their usage of the WMM system. One or more user accounts can be created for each registered seller, depending on how many users need to access the system. For sellers that have multiple business locations, the addresses and contact information for those locations can also be entered into the system. Each user creates a unique user identifier and a 4-digit passcode, both of which will be used to identify the user upon every entry to the system via login and for all activities carried out by the user within the system.

With respect to Consumer Registration and Login in Part 2, registration is not mandatory for consumers to use the system, although a seller who conducts a campaign using the system can determine whether or not consumers are required to register with the system before participating in the campaign. If a campaign requires registration before consumers can participate, than the user-initiated registration procedure is followed. If registration is optional, the system-initiated registration procedure is used. In this case, consumers may be invited to register with the system after having participated in a few campaigns conducted by the wireless shopping network. Once registered, consumers become members of the system, entitling them to participate in any campaign conducted on the system without having to register again. Consumers can register with the system using any of a number of methods supported by the system, including via SMS.

With respect to User-Initiated Registration, and when connecting to the WMM system via a wireless device, the identity information of the subscriber of the wireless device can be used by the system in determining the identity of both prospective new members and registered members. During registration, the use of the identity information of the subscriber associated with the wireless device being used both helps reduce the amount of data entry required and serves as identity verification.

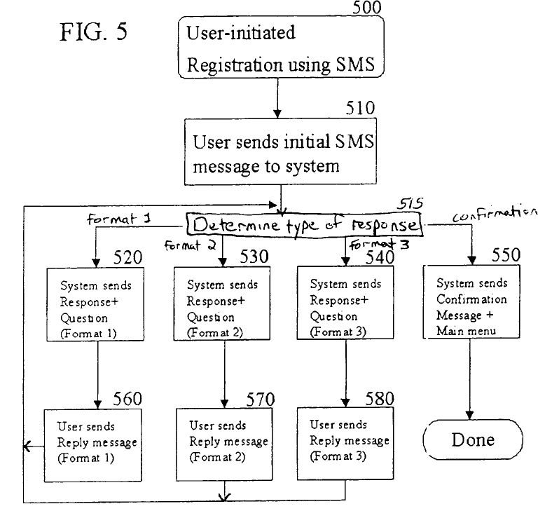

In particular, FIG. 5 is a flow diagram of an embodiment of a User-Initiated SMS-Based Registration routine 500. In this example embodiment, a perspective new member sends in step 510 a SMS-MO message to an access number designated for the wireless shopping network to initiate the registration process via SMS. The SMS message can be blank or contain any designated code word (e.g., as advertised by the wireless shopping network or the seller through the campaign advertisement). Upon receiving the initiating SMS message from the perspective new member, the system first extracts identity information from the wireless network regarding the subscriber (e.g., the subscriber's name, the subscriber identifier, phone number, etc) that is associated with the wireless device from which the SMS message was originated, and then begins sending to the wireless device a series of SMS MT messages that each contain a question. The questions can be in any of three formats, and before sending each message the routine determines in step 515 which format to use. If the format is to be a multiple-choice question where answer choices are numbered (referred to in this example as “format 1”), the routine proceeds to step 520 to send the message in that format. If the format is instead to be a question which can be answered with a free-form response (referred to in this example as “format 2”), the routine proceeds to step 530 to send the message in that format. If the format is instead to be a question which can be answered with a combination of multiple-choice questions are free-form responses (referred to in this example as “format 3”), the routine proceeds to step 540 to send the message in that format.

Replies to questions in format 1 can either be one number when only one answer choice applies or instead more than one number separated by a specified punctuation mark (e.g., a comma), and are sent by the user in step 560. Replies to questions in format 2 can be any number of characters (either in ASCII or Unicode) within the length limit of a SMS message, and are sent by the user in step 570. Replies to questions in format 3 are sent by the user in step 580, and follow a form that enables a combination of replies for questions in formats 1 and 2, where one or more numbered labels can be included by using a separator (e.g., a comma) and where one or more numbered labels can each be attached to a text of any number of characters immediately following the numbered label with a separator (e.g., a colon), and end with a punctuation mark (e.g., a semi-colon).

Thus, prospective new members provide information for use in the registration process by sending the appropriate replies in the form of SMS-MO messages from their wireless devices in response to SMS-MT messages sent from the WMM system. Along with each question, the system may also send along a confirmation of the answer to the last question received. After the user sends the reply messages in steps 560, 570 or 580, the routine returns to step 515. After all the information for the registration has been gathered, the WMM system verifies the information given and then informs the member whether the registration has been successful via another SMS-MT message in step 550. If for some reason the registration fails, the system may send a SMS-MT message to the perspective new member with further instructions.

While not illustrated in this example, system-initiated registration operates in a manner very similar to that of user-initiated registration. In particular, system-initiated registration starts with the WMM system sending an SMS message to a perspective new member, who may have participated in previous campaigns run by the system. If the perspective new member agrees to register, than a series of messages are exchanged between the system and the perspective new member, similar to those described above for user-initiated registration.

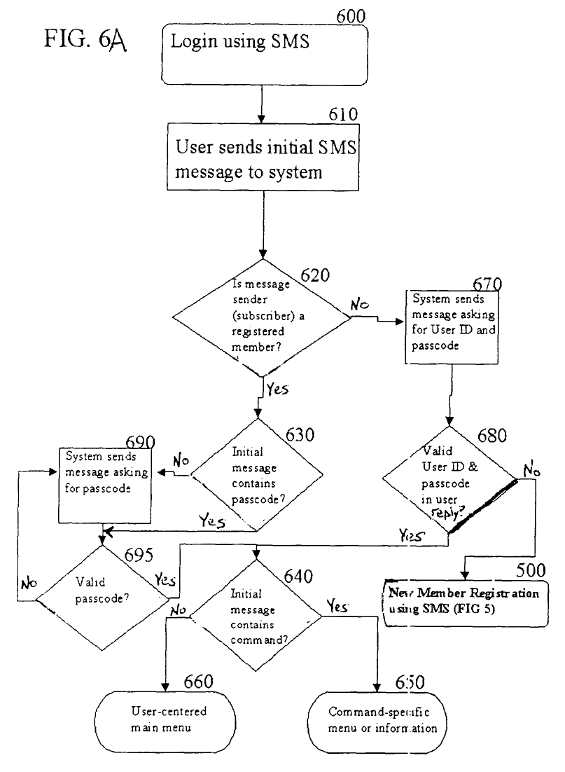

FIG. 6A is a flow diagram of an embodiment of a User-initiated SMS-Based Login routine 600, and FIG. 6B provides examples of SMS messages that could be exchanged as part of the routine. In particular, registered members can use the wireless shopping network by logging in to the system at anytime.

Members can login in a variety of ways in the illustrated embodiment, including via wireless devices, wired devices with Internet access, fixed-line telephones; or by visiting a participating retail store. A login session is the time between when a member's user identifier and passcode has been successfully verified by the system and the time when either the member specifically issues a “Logout” command or when the system automatically ends the session (e.g., after a certain idle period in which the system receives no response message from the member).

Registered members who are wireless subscribers can login to the wireless marketplace via their wireless devices by giving only their passcode, since the wireless shopping network system can link the member's user identifier with their wireless subscriber account in the wireless network, and the WMM system can verify the member's identity without requiring the member to specifically give their user identifier.

The small-sized displays of many wireless devices (e.g., wireless phones) often present challenges for designing effective and usable user interfaces. Short and precise naming of menu texts, short menu length, and display order of information are important factors. A menu system for an interactive SMS application such as the wireless shopping network is particularly challenging due to the length limitation of each message, as each SMS message may need to have enough space for both the actual content of the message and a short menu of user response choices at the end of the message. In order to maximize the space for the actual message content and minimize the need for the user to scroll, the menu choices at the end of each SMS message are designed in the illustrated embodiment to change dynamically based on past and current activity of an individual user. For example, when a member logs in to the system via a wireless device, the system, based on what the member has done in his/her last login session, predicts what activity the member will most likely be interested doing in the new session and accordingly sets up the order of menu items so that the functions most likely to be accessed appear earlier in the menu choices.

Turning now to FIG. 6A, the routine begins in step 610 with the user sending an initial SMS message to the system to begin the login process. The initial message can be in one of the following formats in the illustrated embodiment: 1) [Designated code word for the wireless marketplace service], such as illustrated in example 611; 2) [Designated code word]:[User ID]:[User passcode], such as illustrated in example 612; 3) [Designated code word]:[User passcode], such as illustrated in example 613; and 4) [Designated code word]:[User passcode]:[command], such as illustrated in examples 614 and 615.

Depending on the contents in the initial message, the system checks the subscriber's identity information in step 620, sends back messages requesting any missing information and verifies the responses in steps 670, 630, 695 and 690, and verifies the user ID and user passcode against the system's membership database in step 680. The login is successful when both the user ID and user passcode are successfully verified.

Thus, when logging in via SMS, registered members can speed up the login process by including their passcode in the initial SMS message they send to the system at the beginning of the login session, either by itself or along with any code word designated by the wireless shopping network. Optionally, members can send along any specific command in the initial SMS message should they wish to bypass the main menu of the system to get to certain specific information, as determined and responded to in steps 640 and 650. Otherwise, a user-centered main menu is provided in step 660.

With respect to Consumer Opt-In in Part 3 of FIG. 4, the wireless shopping network in some embodiments periodically invites consumers, registered or not, to select (or opt-in) interest/product categories that match their interests and lifestyles, such as to better understand consumers interests in order to enable sellers to create targeted marketing/sales campaigns. Consumers registered with the system can browse and change their opt-in selections at anytime by logging into the system. Once a consumer opts-into a category, that consumer may receive announcements of sales and/or campaigns on items in that category as they arise. The opt-in categories information is one of the criteria that sellers can base their planned target consumer communities for campaigns.

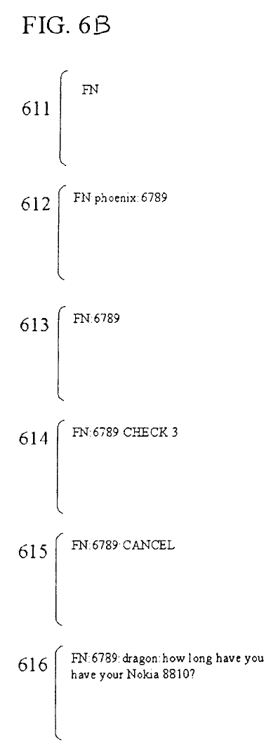

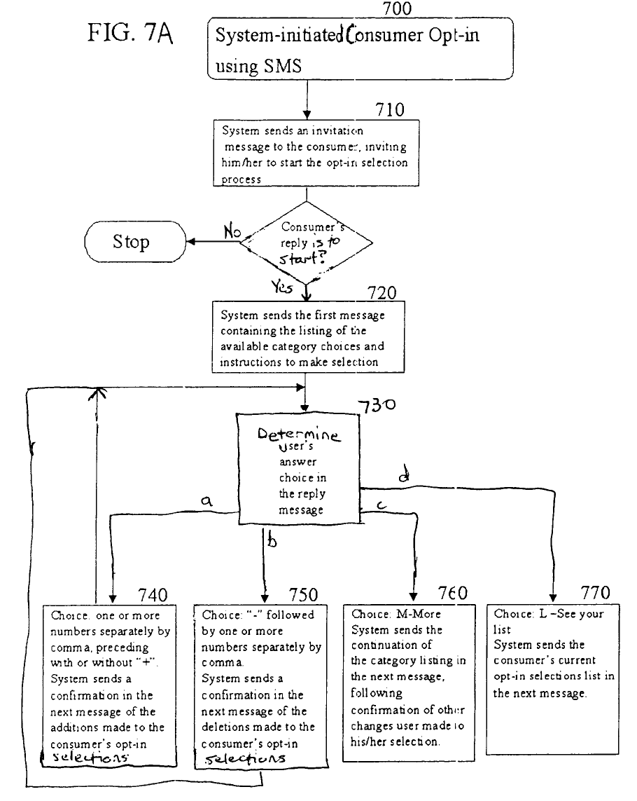

FIG. 7A is a flow diagram of an embodiment of a System-Initiated SMS-Based Opt-In routine, and FIG. 7B provides examples of SMS messages that could be exchanged as part of the routine. In addition, FIG. 8 is a flow diagram of an embodiment of a User-Initiated SMS-Based Opt-In routine.

The opt-in process usually starts with the system sending an invitation message to the consumer in step 710. If the consumer agrees to proceed with the opt-in process, the system sends the consumer a message with a list of category choices and instructions for the consumer to make his/her selection in step 720. When the consumer has initiated the opt-in process with an appropriate indication received in step 820, the routine can immediately proceed to sending the category choice message in step 830.

The consumer can then add, remove, and list all the items on his/her selection list by replying to the system's message(s). If the list of category choices requires more than one SMS message, one of the answer choices in the menu will contain a “More” choice. By selecting it, the consumer tells the system to send the continuation of the list in the next message. In particular, in steps 730 and 840, respectively, the routine analyzes the received response SMS message from the consumer to determine the type of choice made by consumer. Depending on the type of choice made (referred to as “a” to “d” to refer to steps 740, 750, 760 and 770 in FIG. 7A, respectively, and as “a” to “e” to refer to steps 850, 860, 870, 880 and 890 in FIG. 8, respectively), the routine continues to the appropriate step to respond to the indicated choice. After responding to at least some of the indicated choices (e.g., after steps 740, 750, 850 or 860), the routine can return to steps 730 and 840, respectively, to continue. Messages 711-716 in FIG. 7B provide examples of some such messages.

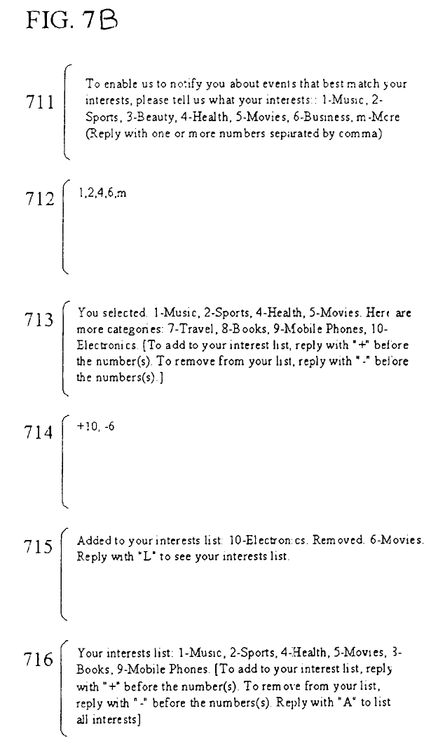

With respect to Campaign Planning in Part 4 of FIG. 4, sellers who registered with the system can in the illustrated embodiment plan for marketing/sales campaigns by entering information such as 1) start and end date of the campaign, 2) the campaign style (i.e., Dutch auction, price-guessing, etc), 3) information about the product being sold or promoted and the quantity, and 4) criteria for winners (i.e., top 50 highest bidders, etc), and 5) product pickup location. FIG. 9 is a flow diagram of an embodiment of a Campaign Planning routine 900, and illustrates the entering of such information in steps 910-950, respectively. Sellers can also use the system to select a subset from the system's database of registered members to be the target consumer community to which to launch the campaign, as shown in step 960. Based on the information entered by the seller, the system can generate a set of pre-defined SMS messages in step 970 that will be sent to the target consumer community throughout each phase of the campaign as appropriate. The sellers can change the content of these pre-defined messages as desired and have full control on the sending of these messages, as shown in step 980. The sellers can also determine which messages will be sent and when they will be sent.

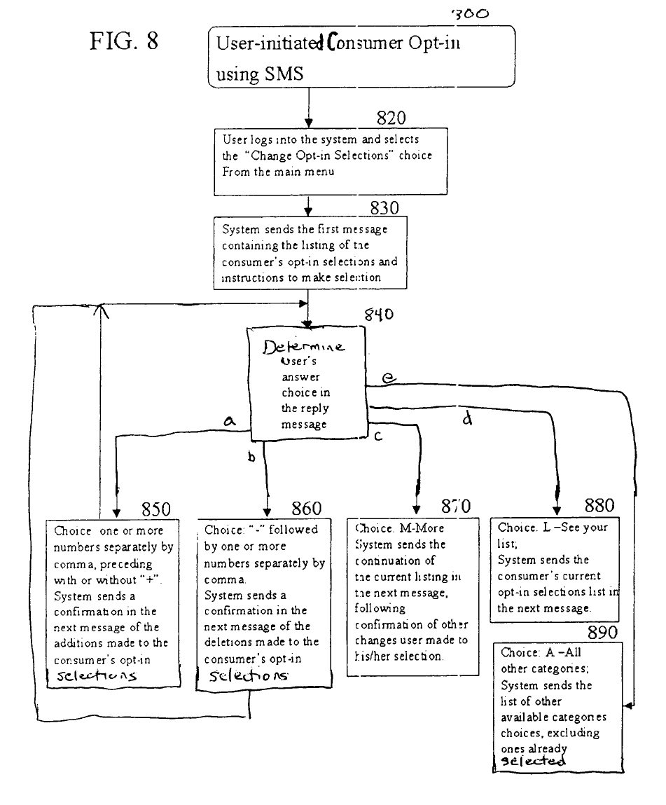

With respect to Campaign Execution in Part 5 of FIG. 4, there are four phases during an execution of a campaign in the illustrated embodiment, with FIG. 10 being a flow diagram of an embodiment of a Campaign Execution routine 1000 that illustrates the phases, and FIG. 11 providing examples of SMS messages that could be exchanged as part of the routine.

In particular, Phase 1, Advertising is where an announcement message about the campaign is sent out to all consumers in the target consumer community in step 1010, which may often include consumers who have opted-in to the category to which the campaign belongs—message 1121 in FIG. 11 is an example of a campaign announcement message. Advertising of the campaign may also be done via medium other than SMS, and consumers who find out about the campaign via other medium may also send a SMS message to the system to obtain instructions to participate.

Phase 2, Consumer Response Collecting, is where consumers who decide to participate in the campaign submit their responses (whether a bid, an answer to a question, a guess on the price of an item, etc.) via SMS in step 1011. Depending on the rules of the campaign, the number of responses a consumer can make may vary, and the system may send a confirmation message back to the consumer for each response submitted—messages 1141 and 1151 in FIG. 11 are examples of a consumer response message and a confirmation message from the system. The seller can also monitor the progress of the campaign by tracking the consumer responses on an up-to-the-minute basis via the system's Web-based user interface.

Phase 3, Campaign Results Notification, begins after the end date of the campaign. The system determines the winners based on the winning criteria set by the seller and the available quantity of the product. A winner notification message, which includes product pickup instructions, will be sent to all the winners in step 1012. Alternatively, a deposit fee can be charged to winners via premium SMS, as discussed in greater detail later. A non-winner notification message will also be sent to all those who participated but did not fall within the winners list—messages 1161 and 1171 in FIG. 11 are examples of the winner and non-winner notification messages.

Phase 4, Product Distribution, is where the product is being distributed to the winners. The system helps the seller track the distribution by recording who picked up the product and who has not in step 1013. A list of winners who have not picked up the product can be generated and a record of them kept on the credit history of each of these consumers. A reminder SMS message will also be sent to winners who did not pick up the product near the last pickup date. The deposit will be confiscated as a no-show charge should a winner fail to pick up the goods.

With respect to Post-Campaign Analysis in Part 6 of FIG. 4, sellers can analyze the results of a campaign after the campaign ends using analytic functions of the system, such as via a Web-based user interface.

With respect to Consumer Account Management in Part 7 of FIG. 4, consumers who registered with the system can access and change their account information, including their opt-in selections, at anytime and from anywhere.

In particular, the consumer can perform any of the following functions listed in the main menu message sent by the system in the illustrated embodiment once the consumer is logged into the system: 1) Change Opt-in Selections; 2) Browse Campaigns in Opt-in Categories; 3) Change User Account Information; 4) Cancel Membership; and 5) Change User Preferences (e.g., to change the frequency of messages that are received).

If the consumer selects the “Change Opt-in Selections” choice, the system will then send a SMS message with the list of the consumer's current opt-in selections and instructions to make changes. FIG. 8 illustrates the flow diagram for the process of a user-initiated consumer opt-in.

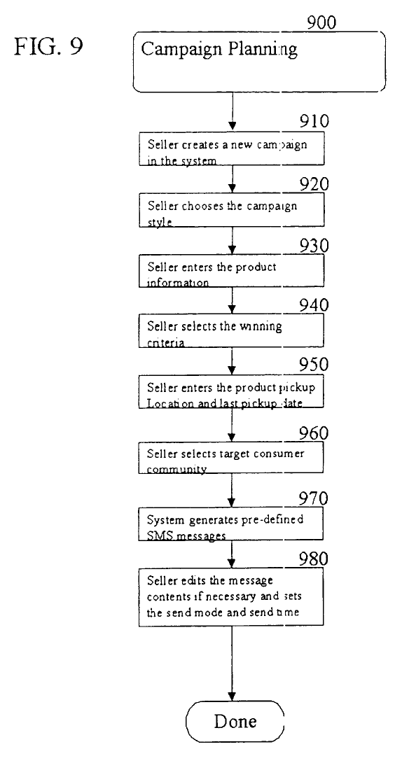

If the consumer selects the “Browse Campaigns in Opt-in Categories” choice, the system will then send a SMS message with the list of the opt-in categories, with a number next to each indicating number of campaigns in that category. The consumer then chooses the category he/she wishes to browse, and the system then returns with a list of campaigns currently running in that category. FIG. 12 illustrates an example sequence of messages exchanged between the consumer and the system during this operation.

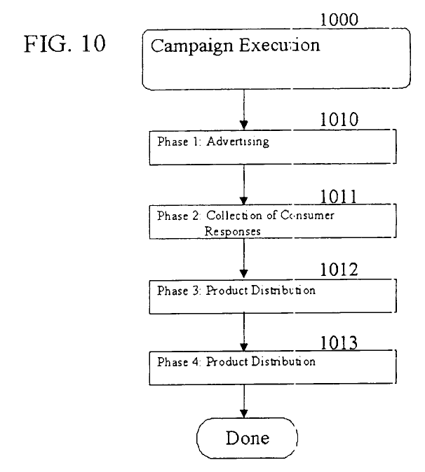

If the consumer selects the “Change User Account Information” choice, the system will send a SMS message listing the current personal information in the consumer's account with instructions to make changes. FIG. 13 shows an example of that message.

If the consumer selects the “Cancel Membership” choice, the system will send a SMS message confirming the consumer's request to cancel his/her membership.

As previously noted, the wireless marketplace service can in some embodiments collect fees on various of the services provided to its members. Such fees can include, for example, monthly subscription fees, registration fees, accessing fees (e.g., to access information, such as information about a specific auction or a list of available auctions), participation fees (e.g., for participating in specified auctions, such that different auctions may have different participation fees based on the seller and/or on other characteristics of the auctions; for participating in any auction; for participating in a non-auction shopping or selling process, etc.), deposit fees (e.g., for goods won by and/or purchased by a member), priority matching fees and no-show fees (e.g., to charge a winner of a product a fee if the winner does not pick up the product within a specified period of time). In embodiments in which wireless services such as SMS are used, the monthly billing for these services by the wireless network operators is one convenient and logical method for tracking and collecting such fees, which provides an opportunity for the wireless marketplace service provider to share revenue with the wireless network operators.

Depending on the actual billing mechanism supported as well as the business model required by wireless operators, the service fee can be charged in various manners. One example is through a Premium SMS service, such as by having reply messages from consumers routed to appropriate Premium SMS billing numbers that will cause charges to be applied to that customer's bill. In that way, the operators charge the users via an existing monthly bill, and both the service provider and operators can share revenue resulting from the services. Such charges are preferably in smaller amounts, as it would otherwise present significant account receivable risk to operators. In other embodiments, a variety of other billing mechanisms are used, such as any other type of billing mechanism provided by or available to an operator of a wireless network that provides service to a user. Such billing mechanisms in use by wireless network operators may in turn interact with other computing systems as appropriate, such as one or more banking systems.

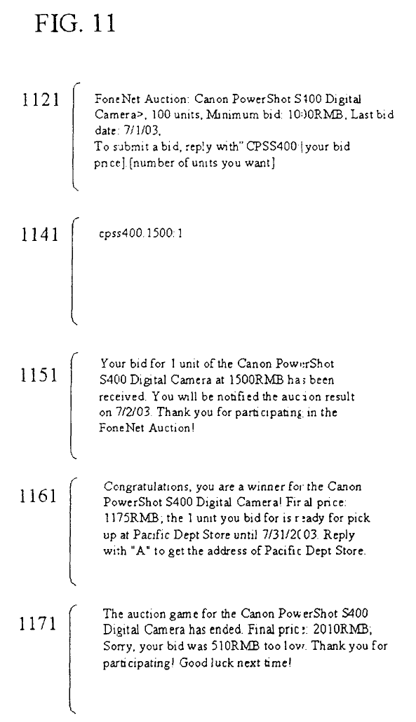

As one example of a back-end system architecture to support the various functionality described above, FIG. 14 is a network diagram illustrating interactions between various devices and modules in one embodiment of a wireless marketplace. In particular, there are five functional blocks in FIG. 14, those being a wireless gateway 1401 (e.g., an SMS gateway), a load balancer 1402, one or more SMS interface modules 1403, one or more shopping campaign transaction manager modules 1405, a shopping campaign manager module 1407, and a relational database 1406.

The campaign manager module performs a variety of activities directed toward initiating and executing campaigns. In particular, the module can interact with users to define the parameters of campaigns, can identify target users for a campaign (e.g., by matching user profiles to criteria specified for the campaign), can execute campaigns (e.g., by sending out specified messages to targeted users during specified phases of the campaign and/or by monitoring campaign requirements or other criteria to ensure that they are satisfied), and can provide campaign-related information to sellers and others to allow them to monitor ongoing campaigns.

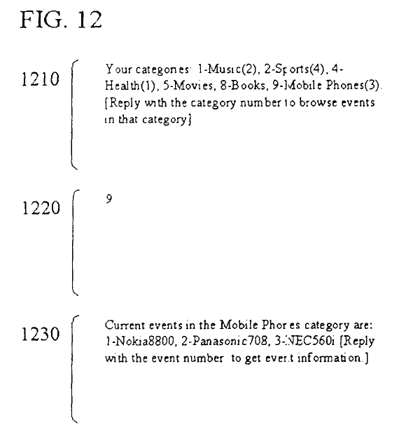

The transaction manager module performs a variety of the described functionality of the WMM system, and FIG. 15 is a network diagram illustrating additional details about interactions in a transaction manager module in one embodiment. In particular, a Transaction State Manager 1411 dispatches incoming transaction requests to various modules depending on the type of campaigns. These destination modules include an Account Manager module 1413, which interacts with the database 1406 to manage accounts (e.g., create and delete user accounts, search user accounts, etc.); a Billing Manager module 1416, which in the illustrated embodiment interfaces with a wireless carrier to bill a user in his/her monthly bill from the wireless carrier; an Activity and Profile Manager module 1415, which tracks accounts to generate both user profiles and object profiles (e.g., most popular goods); and a Push/Alert Manager module 1414, which provides information for time-dependent subscribed services (e.g., last-minute sales).

Useful goals with respect to the system design include high availability (e.g., providing 99.999%) uptime), high scalability (e.g., as the number of users increases, scaling linearly to support the users efficiently), and high robustness (e.g., built-in fault tolerance). Particular benefit is received from satisfying such goals in embodiments in which SMS is used, based in part on the fact that SMS is not a real-time interactive communication mechanism. However, since a user will typically assume that once thy have sent out a SMS that an appropriate response will occur, it is beneficial from the user satisfaction standpoint for the system to reliably process all incoming messages without dropping any one of them.

As a result, in some embodiments a stateless system design is adopted to support the above goals. Such a design can increase response time, but any extra delay incurred with storing and retrieving states from a database is small compared with existing network delays, particularly since SMS is not real-time. The stateless design is reflected in FIG. 14, in which all of the modules store and retrieve relevant state information from a centralized database.

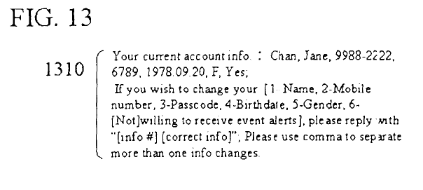

The SMS Interface module (“SIM”) coordinates communications between the WMM system and an external device that supports SMS, and FIG. 16 is a network diagram illustrating additional details about interactions in a SMS Interface module in one embodiment. In particular, the SMS Interface module performs the following functions: send and receive SMS messages in 1501 by communicating with carrier SMS gateway 1401; parse received SMS messages in 1502 to generate request objects (Request); generate the request objects in 1503; store the Request object in 1504 into a request object queue in database 1406; retrieve outbound SMS messages in 1507 from a queue of response objects (Response); process the response objects in 1506; and convert the response objects into SMS messages in 1505 via an SMS generator. As the load increases, it can be beneficial to have SIM on a separate server to increase robustness.

Also, since SMS transmission is not ack'ed but users will assume that delivery has occurred, it is preferable to process each inbound SMS message without loss, and to re-send at least some outbound SMS messages until confirmation is received that the intended recipient has received it. In the illustrated embodiment, such operations are handled by the transaction manager. Likewise, it is preferable that SIM be stateless for high robustness and scalability, and it is also cheaper to load balance SIM this way (e.g., via a vanilla stateless Cisco load balancer placed in front of SIM). This can be accomplished by storing processed Request objects into a queue in the database, and sending a broadcast message to all Transaction Managers when the queue is empty. When the queue is not empty, SIM will select the request objects one by one from the queue and lock the object until it is fully processed, continuing to process the queue until it is empty. Preferably, the lock on an object can be removed when a server is down, such as by sweeping the queue whenever down servers are detected.

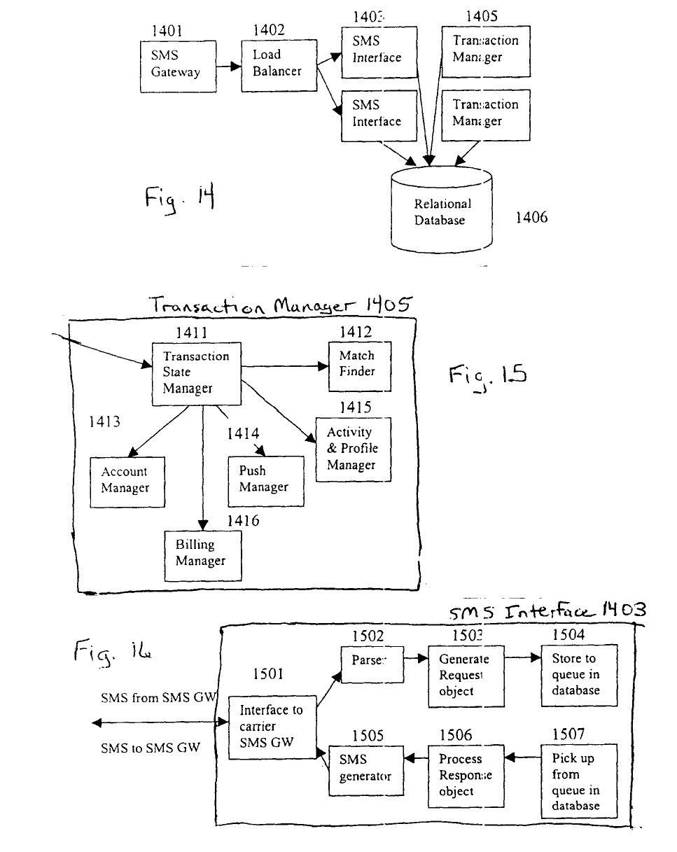

As previously noted, the Transaction State Manager (“TSM”) module 1411 coordinates various transaction interactions, with FIG. 17 being a flow diagram illustrating additional details about processing performed by the module in one embodiment. In particular, in the illustrated embodiment it retrieves a request object from the request queue and performs the following functions depending on the various stages of transactions: retrieves request objects from the queue in the database until the queue is empty, and then waits for SIM notification by monitoring a broadcast port when the queue is empty; calls the account manager (ACCTM) in 1602 to retrieve account information based on a user id identified in 1601; sets up a new account in 1603 if the retrieved account doesn't exist; optionally authenticates the user in 1604 based on passcode and/or other information; replies to the sender with a confirmation in 1605; queues all incoming request objects into a database in 1606; finds matches using the requests in 1607 after the campaign deadline is reached; receives matched list from match maker and notifies winners in 1608; sends the winner list to the billing system for generating bills; and interfaces with the relational database system to store and retrieve states and other data objects.

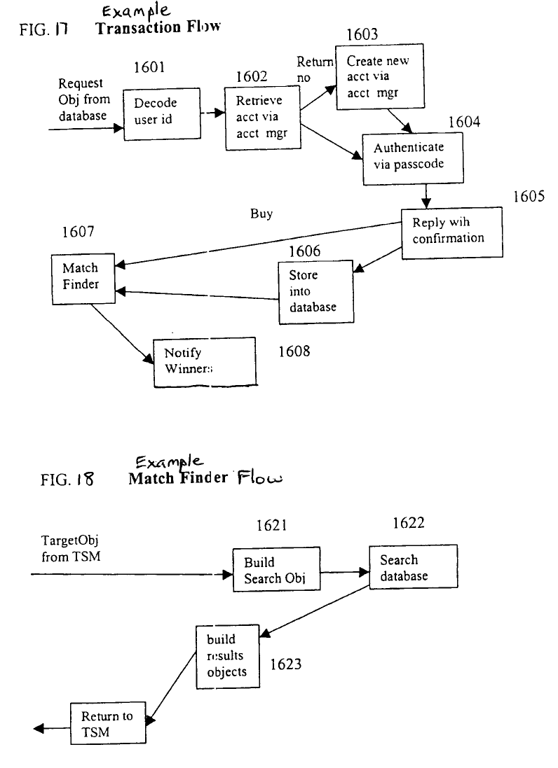

The Match Finder (“MF”) module 1412 identifies winners of auctions, with FIG. 18 being a flow diagram illustrating additional details about interactions in a Match Finder module in one embodiment. In particular, in the illustrated embodiment it searches for matches for winners by performing the following functions: receives a match finding request from TSM (in other embodiments, a match request queue is created and used in a similar fashion to the communications between SIM and TSM); processes the match request to generate a search object in 1621 that contains search criteria; dynamically generates an SQL command or uses a pre-built command to search the database in 1622 based on the search object; builds a results return object in 1623 if results exist; and send the return object back to TSM.

Those skilled in the art will also appreciate that in some embodiments the functionality provided by the routines discussed above may be provided in alternative ways, such as being split among more routines or consolidated into less routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other embodiments the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Accordingly, the invention is not limited except as by the appended claims and the elements recited therein. In addition, while certain aspects of the invention are presented below in certain claim forms, the inventors contemplate the various aspects of the invention in any available claim form. For example, while only some aspects of the invention may currently be recited as being embodied in a computer-readable medium, other aspects may likewise be so embodied.

What is claimed is:

1. A method for an auction-based shopping server system to establish a wireless marketplace for selling products to users of wireless cellular telephones via Dutch auctions, the method comprising, under control of the shopping server system:
receiving information for each of multiple users of wireless cellular telephones that indicates one or more categories of products of interest to that user;
for each of multiple sellers of products, assisting the seller in establishing a sales campaign for each of one or more Dutch auctions, by
for each of one or more products that are each to be offered by the seller as part of a Dutch auction, receiving description information from the seller of a planned sales campaign for the Dutch auction for the product, the description information indicating multiple copies of the product available as part of the Dutch auction and indicating criteria for buyers to win the Dutch auction so as to acquire one or more of the multiple available copies;
for each of the Dutch auction sales campaigns, determining multiple of the users of the wireless cellular telephones that are appropriate for the sales campaign, the determining of the appropriate users based at least in part on the product category interest information received from those users; and
for each of the users determined to be appropriate for a Dutch auction sales campaign, sending a notification message to that user of the Dutch auction, the sent notification message being an SMS message such that the user can place a bid for one or more of the copies of the product available as part of that Dutch auction by replying to the notification SMS message; and
assisting in completing multiple of the Dutch actions by, for each of those Dutch auctions,
receiving bids from multiple of the users that are each for one or more of the copies of the product available as part of the Dutch auction, the bids received as SMS messages;
determining winners of the Dutch auction based at least in part on the received bids and on the indicated criteria for the Dutch auction;
notifying the seller for the Dutch auction of the determined winners of the Dutch auction and/or notifying each of the determined winners of the Dutch auction of a quantity of copies of the product for the Dutch auction that the determined winner has won; and
delivering the copies of the product for the Dutch auction to the determined winners of the Dutch auction by,
for each of one or more of the determined winners, notifying that determined winner of a geographical pick-up location at which to obtain the one or more copies of the product that that determined winner has won and providing those copies of the product to that determined winner at that pick-up location; and
for each of the determined winners that are not notified of a geographical pick-up location, obtaining a geographical delivery location from that determined winner and delivering the one or more copies of the product that that determined winner has won to that delivery location, so that users of wireless cellular telephones can shop for products by receiving notification of Dutch auctions for the products and by placing bids on those Dutch auctions from their wireless cellular telephones.

2. The method of claim 1 wherein replies by the users to the notification SMS messages use Premium SMS to enable billing of those users based on the replies.

3. The method of claim 1 including, under control of a computing device of one of the sellers:
sending description information to the shopping server system for a sales campaign for a Dutch auction for a product offered by the one seller; and
before receiving notification from the shopping server system of winners of the Dutch auction, monitoring the sales campaign by obtaining information from the shopping server system that indicates bids received from users for the Dutch auction.

4. The method of claim 1 including, under control of the wireless cellular telephone of one of the users:
receiving a notification SMS message from the shopping server system for a sales campaign for a Dutch auction having multiple available copies of a product, the received SMS message indicating multiple options for responding with a bid for one or more of the available product copies; and
in response to an instruction from the one user, sending a reply SMS message for the received notification SMS message that includes a bid for multiple of the available product copies at a specified bid price, the included bid based on a selected one of the indicated multiple options for responding.

5. The method of claim 1 including, under control of the wireless cellular telephone of one of the users:
receiving one or more SMS messages from the shopping server system that each indicate one or more categories of products of potential interest to the one user, the SMS messages received as part of a registration process for potential buyers; and
sending one or more response SMS messages to the shopping server system such that at least one of the sent response SMS messages indicates one or more categories of products of interest to the one user.

6. The method of claim 1 including, under control of the wireless cellular telephone of one of the users:
requesting information from the shopping server system about currently available auctions, the requesting by sending one or more SMS messages to the shopping server system;
receiving in response indications from the shopping server system of multiple currently available auctions of which the one user was not previously sent notifications; and
in response to an instruction from the one user, initiating a bid for one of the indicated auctions by sending to the shopping server system an SMS message that indicates the one indicated auction and indicates a bid for that auction.

7. The method of claim 1 wherein the criteria indicated for each of the Dutch auctions for buyers to win that Dutch auction includes a minimum bid price, and wherein the determining of the winners of each of the Dutch auctions includes repeatedly selecting a remaining unselected one of the buyers for that Dutch auction as one of the winners of that Dutch auction based on the bid price of that one buyer for that Dutch auction being highest among the bid prices for that Dutch auction of the unselected buyers and being above the minimum bid price for that Dutch auction, the selecting continuing until the selected winners have aggregately placed bids for each of the multiple available copies of the product for that Dutch auction or until there are no more remaining unselected buyers with bid prices for that Dutch auction above the minimum bid price for that Dutch auction.

8. The method of claim 1 wherein the description information for the sales campaign for one of the Dutch auctions further indicates demographic information regarding users to be notified of the Dutch auction, and wherein the indicated demographic information is used by the shopping server system during the determining of the multiple appropriate users for that Dutch auction.

9. The method of claim 1 wherein the description information from one of the sellers for the sales campaign for one of the Dutch auctions further indicates content for each of multiple messages that are each to be sent during an indicated one of multiple phases of the sales campaign to the users determined to be appropriate for the one Dutch auction, and wherein the assisting of the one seller in establishing the sales campaign for the one Dutch auction includes sending each of the multiple messages to each of those determined appropriate users as an SMS message during the indicated phase of the sales campaign for that message.

10. The method of claim 1 including, under control of the shopping server system, receiving location-based information for one of the users in an automated manner, and using the received location-based information in the determining of that user as one of the multiple appropriate users for one of the Dutch auctions and/or in selecting that user as one of the determined winners for one of the Dutch auctions and/or in determining how to deliver to that user one or more product copies that the user won for one of the Dutch auctions and/or in automatically determining a billing procedure for that user for one or more product copies that the user won for one of the Dutch auctions.

11. A computer-implemented method for selling items to users of wireless devices via auctions, the method comprising:
receiving information about multiple users of wireless devices;
receiving information about an auction for one or more items available from a seller;
automatically selecting a subset of the multiple users to notify about the auction as potential buyers for one or more of the items from the auction;
sending messages to the selected users that indicate the auction for the one or more items and that indicate multiple options for responding;
obtaining response messages from multiple of the users that each specify at least one of the multiple options; and
automatically selecting one or more of the users from whom response messages were obtained to purchase one or more of the items from the auction based at least in part on the response messages.

12. The method of claim 11 wherein the method is performed for each of multiple auctions, and wherein at least some of the auctions are Dutch auctions.

13. The method of claim 12 wherein each of the auctions is a Dutch auction, and wherein each of the Dutch auctions offers multiple items that are copies of a single product such that multiple users are selected to each purchase at least one of the items.

14. The method of claim 12 wherein each of the Dutch auctions includes minimum criteria that must be satisfied by a user providing a response message in order for that user to be selected to purchases one or more of the items from the auction.

15. The method of claim 11 wherein the method is performed for each of multiple auctions, and wherein each of the auctions use a traditional auction format.

16. The method of claim 11 wherein the method is performed for each of multiple auctions, and wherein each of the auctions use a reverse auction format.

17. The method of claim 11 wherein each of the auctions offers multiple items, and wherein the multiple items of each of the auctions are such that two or more of the multiple items are of a distinct type.

18. The method of claim 11 wherein the messages sent to the selected users are SMS messages.

19. The method of claim 11 wherein the response messages from the users are SMS messages.

20. The method of claim 11 wherein the messages sent to the selected users and the response messages from the users are MMS messages.

21. The method of claim 11 wherein the messages sent to the selected users and the response messages from the users are instant messages.

22. The method of claim 11 wherein each of the response messages from one of the users is generated by an application executing on the wireless device used by that user.

23. The method of claim 22 wherein the executing applications are applets sent to the wireless devices by a computing device executing the method.

24. The method of claim 11 wherein the received information about the auction indicates information related to a sales campaign for the auction, and including executing the sales campaign for the auction based at least in part on the indicated information.

25. The method of claim 24 including providing status information about the execution of the sales campaign to the seller during the execution so as to enable the seller to monitor the sales campaign.

26. The method of claim 24 wherein the received information related to the sales campaign indicates a type of user that is appropriate for the auction, and wherein the selecting of the subset of users to notify about the auction includes selecting users of the indicated type.

27. The method of claim 24 wherein the information related to the sales campaign includes information related to multiple messages that have specified content and that are each to be sent to each of the selected users when distinct specified conditions are satisfied, and wherein the executing of the sales campaign includes sending each of the multiple messages to each of the selected users when the specified conditions for that message are satisfied.

28. The method of claim 11 wherein the received information from the seller about the auction includes indications of content for each of multiple messages that are to be sent to appropriate users before completion of the auction, wherein the message sent to the selected users includes the content indicated for one of the multiple messages, and including sending a series of other messages to the selected users such that each of the messages in the series includes the indicated content for one of the other multiple messages.

29. The method of claim 11 including notifying users other than the selected users in a manner other than by sending messages to the other users.

30. The method of claim 11 including notifying users about the auction in a broadcast manner.

31. The method of claim 30 wherein the broadcast notifying of users about the auction includes advertising the auction using an information distribution medium in such a manner that the advertising is available to all users with access to the information distribution medium.

32. The method of claim 11 wherein the sending of the messages to the selected users that indicate the auction is performed by sending a single message to each of multiple available users, and wherein the selected users are a subset of the multiple available users.

33. The method of claim 11 including notifying users about the auction in a targeted manner by advertising the auction using an information distribution medium in such a manner that the advertising is available to only designated users with access to the information distribution medium.

34. The method of claim 11 including receiving a response message from a user other than one of the selected users that includes a bid amount, and wherein the automatic selecting of the users includes selecting the other user.

35. The method of claim 11 wherein the received information about the multiple users includes information received from each of at least some of the users that indicates preferences of that user regarding receiving information about items, and wherein the selecting of the subset of users to notify about the auction for the available items is based at least in part on the received preference information.

36. The method of claim 35 wherein the preference information received from at least some of the users indicates one or more types of items of interest to those users, and wherein the preference information from each of those users is received via one or more SMS messages from that user that are responses to messages sent to that user as part of a registration process.

37. The method of claim 35 wherein the received preference information from each of those users is received via one or more MMS messages.

38. The method of claim 35 wherein the received preference information from each of those users is received via one or more instant messages.

39. The method of claim 35 wherein the received preference information from each of those users is provided by an applications executing on the wireless devices of those users.

40. The method of claim 35 wherein the received preference information from each of those users is received as part of a registration process initiated by a computing system executing the method.

41. The method of claim 35 wherein the received preference information from each of those users is received as part of a registration process initiated by that user.

42. The method of claim 11 including billing each of the selected users for the items purchased by that user.

43. The method of claim 42 wherein at least some of the multiple options for responding indicated by the messages sent to the selected users are such that performing the responding for those options generates an event that is billable to a user performing the responding, and wherein the billing of the selected users is based on the generated events for the selected users.

44. The method of claim 42 wherein the billing of the selected users is based on Premium SMS.

45. The method of claim 42 wherein the billing of the selected users is performed using a billing mechanism provided by a wireless service operator that provides service to the wireless devices of the selected users.

46. The method of claim 42 wherein the billing of the selected users is performed by charging credit cards of the selected users.

47. The method of claim 42 wherein the billing of the selected users is performed via store credit for the selected users that is provided by the seller.

48. The method of claim 42 wherein the billing of each of the selected users is performed at a time of delivery to the selected user of the one or more items purchased by that selected user.

49. The method of claim 11 including using Premium SMS to bill at least one of the selected users for a periodic subscription fee related to the auctions.

50. The method of claim 11 including using Premium SMS to bill at least one of the selected users for a participation fee related to participating in the auction.

51. The method of claim 50 wherein the participation fee is specific to the auction.

52. The method of claim 11 including using Premium SMS to bill at least one of the selected users for a deposit fee related to the one or more items from the auction to be purchased by that user.

53. The method of claim 11 including using Premium SMS to bill at least one of the selected users for a no-show fee related to that user not completing the purchasing of the one or more items from the auction for which that user was selected.

54. The method of claim 11 including receiving location-based information for one or more of the multiple users, and using the received location-based information for one or more of the selecting of the subset of users, the sending of the messages, and the selecting of the one or more users.

55. The method of claim 54 wherein the location-based information for the multiple users is received from an operator of a wireless service that is used by the wireless devices of those users.

56. The method of claim 11 including receiving location-based information for one or more of the multiple users, and using the received location-based information for performing advertising for the auction at a physical location accessible to those users.

57. The method of claim 11 including receiving location-based information for one or more of the multiple users, and using the received location-based information to assist the users in finding a physical auction location at which the users can receive the items from the auction that were purchased by those users.

58. The method of claim 11 including receiving location-based information for one or more of the multiple users, and using the received location-based information to assist the users in finding a physical retail store at which the users can obtain the items from the auction that were purchased by those users.

59. The method of claim 11 including receiving location-based information for one or more of the multiple users, and using the received location-based information for delivering to those users the items from the auction that were purchased by those users.

60. The method of claim 11 including receiving location-based information for one or more of the multiple users, and using the received location-based information for obtaining payment from those users for items from the auction that were purchased by those users.

61. The method of claim 11 wherein at least one of the multiple options for responding is to place a bid for one or more of the available items, and wherein at least some of the response messages each specify a bid amount for a specified group of one or more of the available items.

62. The method of claim 61 wherein the selecting of the users to purchase the items includes using the specified bid amounts from the response messages obtained from the selected users to determine a purchase price for the available items.

63. The method of claim 11 including, after the selecting of the users, notifying the selected users via an SMS message.

64. The method of claim 11 including, after the selecting of the users, notifying the seller of the purchasing of the available items by the selected users.

65. The method of claim 11 wherein the wireless devices are wireless telephones.

66. A computer-readable medium whose contents cause a computing device to offer items to wireless telephone users, by performing a method comprising:
receiving information about one or more available items;
notifying multiple users of wireless telephones about the available items;
obtaining messages from multiple of the users that are each sent by one of the users via one of the wireless telephones and that each specify a level of interest of the user in one or more of the available items; and
selecting one or more of the users from whom messages were obtained to receive one or more of the items based at least in part on the response messages.

67. The computer-readable medium of claim 66 wherein the items are available as part of an auction using a traditional auction format.

68. The computer-readable medium of claim 66 wherein the items are available as part of an auction using a Dutch auction format.

69. The computer-readable medium of claim 66 wherein the items are available as part of an auction using a reverse bidding format.

70. The computer-readable medium of claim 66 wherein the items are available as part of a fixed price offer.

71. The computer-readable medium of claim 66 wherein the items are available using a price guessing mechanism.

72. The computer-readable medium of claim 66 wherein the items are available using a price naming mechanism.

73. The computer-readable medium of claim 66 wherein the items are available using a one-price bidding mechanism.

74. The computer-readable medium of claim 66 wherein the items are available using a last minute sales mechanism.

75. The computer-readable medium of claim 66 wherein the items are available using a mass buying mechanism.

76. The computer-readable medium of claim 66 wherein the items are available using a mass selling mechanism.

77. The computer-readable medium of claim 66 wherein the messages obtained from the multiple users are SMS messages and wherein the notifying of the multiple users is performed using SMS messages.

78. The computer-readable medium of claim 66 wherein the method further includes using Premium SMS to bill at least some of the notified users in such a manner as to reflect their participation in the offering of the available items.

79. The computer-readable medium of claim 66 wherein the notifying of the multiple users is performed in a manner that does not use the wireless telephones of the users.

80. The computer-readable medium of claim 66 wherein the notifying of the multiple users is performed via a broadcast mechanism available to the multiple users and to others.

81. The computer-readable medium of claim 80 wherein the broadcast mechanism is television.

82. The computer-readable medium of claim 80 wherein the others include users of wireless devices other than wireless telephones.

83. The computer-readable medium of claim 80 wherein the available items are made available as part of an ongoing selling mechanism, and including, after the notifying of the multiple users about the available items, providing multiple update notifications to the multiple users in such a manner as to allow the multiple users to monitor progress of the ongoing selling mechanism.

84. The computer-readable medium of claim 83 wherein the providing of the update notifications to the multiple users is performed via the broadcast mechanism that is available to the multiple users and to the others.

85. The computer-readable medium of claim 66 wherein the notifying of the multiple users is performed by providing IVR capabilities that supply information about the available items to each of the multiple users.

86. The computer-readable medium of claim 85 wherein the supplying to each of the multiple users of the information about the available items via the IVR capabilities is performed after that user initiates a telephone call to access the IVR capabilities.

87. The computer-readable medium of claim 85 wherein the obtaining of the messages from multiple of the users includes receiving information supplied by those users via the provided IVR capabilities.

88. The computer-readable medium of claim 66 wherein the computer-readable medium is a memory of a computing device.

89. The computer-readable medium of claim 66 wherein the computer-readable medium is a data transmission medium transmitting a generated data signal containing the contents.

90. The computer-readable medium of claim 66 wherein the contents are instructions that when executed cause the computing device to perform the method.

91. A computing system for making items available to wireless telephone users via auctions, comprising:
a transaction manager component able to obtain information about multiple users of wireless devices and to obtain information about an auction for one or more available items, the auction having specified criteria related to determining one or more winners of the auction;
a messaging component able to send messages to at least some of the multiple users that indicate the auction for the one or more items and to obtain response messages from multiple of the users that each specify an interest of the user in acquiring one or more of the available items; and
a match finder component able to automatically determine one or more of the users to each acquire one or more of the available items from the auction based at least in part on the response messages.

92. The computing device of claim 91 wherein the transaction manager component and the match finder component are executing in memory of the computing device.

93. The computing device of claim 91 wherein the transaction manager component consists of means for obtaining the information about the multiple users and for obtaining the information about the auction, wherein the messaging component consists of means for sending messages to the users and for obtaining response messages from the users, and wherein the match finder component consists of means for automatically determining users to acquire the available items from the auction.
